(19) United States
(12) Patent Application Publication
(10) Pub. No.: US 2014/0236772 A1
(43) Pub. Date: Aug. 21, 2014

(54) SYSTEM AND METHOD FOR DIGITAL WRITER-READER CONTENT CREATION AND DISTRIBUTION

(71) Applicants: Annemarie McCoy, East Hampton, NY (US); Adrienne Kitaeff, East Hampton, NY (US)

(72) Inventors: Annemarie McCoy, East Hampton, NY (US); Adrienne Kitaeff, East Hampton, NY (US)

(21) Appl. No.: 14/181,143

(22) Filed: Feb. 14, 2014

Related U.S. Application Data
(60) Provisional application No. 61/765,286, filed on Feb. 15, 2013.

(51) Int. Cl. G06Q 30/06; G06Q 20/06

(52) U.S. Cl. CPC G06Q 30/0635; G06Q 20/06
USPC 705/26.81

(57) ABSTRACT

A system and method for creation and distribution of writer-reader content through a social publishing service are described. The social publishing service directly connects readers with writers, using words as the unit of currency for transactions. Readers may purchase amounts of words to use as currency, which are then included in a user account and can be exchanged for corresponding word amounts of writer-reader content. Writers within the system may then be paid based on the number of words of their works purchased by readers. The social publishing service provides a platform for commerce transactions between writers and readers, gamification of that transaction process, as well as providing modules within a user interface allowing for users to search for, read, write, review and/or or edit writer-reader content.

### CROSS REFERENCE TO RELATED APPLICATIONS

This application claims priority to and the benefit of U.S. Provisional Application No. 61/765,286, filed Feb. 15, 2013, the contents of which are incorporated herein by reference.

### TECHNICAL FIELD

The present invention is directed to the creation and distribution of writer-reader content, and more particularly to a system and method that directly connects readers with writers through a social publishing service, using words as the unit of currency for transactions. The social publishing service provides a platform for commerce transactions between writers and readers, gamification of that transaction process, as well as providing modules within a user interface allowing for users to search for, read, write, review and/or or edit writer-reader content.

### BACKGROUND OF THE INVENTION

In traditional ink and paper print publishing, writers were limited in the audience they could reach, and readers were likewise limited in the written material available to them. Writers hoping to gain wide distribution of their works had to find a way into a small group of major publishing houses. Readers were often limited to seeing only the works distributed into their local bookstores by these same major publishing houses. However, with the growing popularity of digital publishing content, the publishing industry—from books and blogs to magazines and newspapers—is in a tremendous state of change. With digital content, a writer can reach any reader with access to the internet. Likewise, readers can now search for and find new writers and materials previously unavailable to them in brick and mortar stores. Along with this, social media has allowed for both writers and readers to interact in real time, providing updates, reviews, alerts, discussion, and even sharing or referring digital content.

Yet the traditional book publishing business model is still basically the same for the majority of sales of literary works between writers and readers. A small, select group of major publishing houses are still responsible for putting out most of the books in the best-seller aisle of local bookstores or online retailers, and still provide the majority of works widely available as digital content. This model creates a roadblock for many aspiring writers who do not have the connections or means to gain access to these major publishing houses, as it is next to impossible for a new writer to become a part of these publishing houses without a literary agent.

As a result of this limitation, writers and readers have embraced alternatives made possible by the advancements in online and digital publishing. Self-publishing is gaining acceptance as a respectable channel for readers to discover new published material. However, writers choosing to self-publish must deal with the entrepreneurial activity required to sell their works to readers. Self-publishing writers must set their own price, connect with readers and market their product, which can be a challenge for many writers. Writers, whether self-published or supported by the corporate structure of a publishing company, still rely on readers to pay their wages.

The introduction of online digital content, followed by the increase in digital e-readers, has created a shift in how written content is distributed from writers to readers as mentioned above. With the advancements in digital content, it has become easier for readers to obtain printed content, while it is also easier for a writer to publish content. Despite these advancements, the way in which writers are paid and the way in which readers purchase content has remained relatively static. Writers still rely on contracts with publishers for payment for works they create, and readers still purchase digital works on the set price per work as with ink and paper works.

Additionally, although there is more immediate access to digital content as opposed to printed publications, there is not yet a sufficient link between writers and readers to make the content as accessible as possible. There is also not a comprehensive platform allowing users to browse and purchase content, read content, write and edit content, and review content, without being limited by the traditional model of paying fixed prices for individual, complete works.

### SUMMARY

The present application is directed to a social publishing service of digital writer-reader content that creates an online community, directly linking readers, writers, editors, agents, publishers, advertisers, bookstores, sponsors, literacy advocates, universities, and/or libraries. In particular, the social publishing service directly links readers with writers, allowing readers to purchase a writer's works using words as currency, as described in more detail below. The social publishing service includes a host computer or server, which stores digital writer-reader content and executes programming modules to host a website or application program facilitating interactions with the users. Writer-reader content may include, for example, original works created by writers, individual works and/or compilations of works created by writers, an editor or publishing company, compilations of writers' works, and reviews/ratings/comments posted by readers. Compilations of works created by writers may be created by individuals or organizations. These compilations may be created within the social publishing service, or may be created outside of the social publishing service and uploaded to the service using a user device. Compilations may be made by readers from content within the social publishing service, if writers have given permission for their work to be included in such compilations. Writers may give permission within the metadata of an uploaded work, or may give permission as part of their member profile. For example, a reader may make a compilation of poems from the works of various writers, or from multiple poems by a single writer.

The social publishing service, through the programming modules, provides a user interface accessible as a website or within an application program. The user interface contains modules allowing a user to read writer-reader content already stored within a server or database maintained by the social publishing service, to draft new writer-reader content which may then be made available to other users for purchase, to comment on or review writer-reader content, and to edit existing writer-reader content. The social publishing service further provides a portal for commerce transactions involving the digital content, with readers purchasing the content and writers selling the content. When a reader makes a purchase, information regarding the transaction is sent to the host computer or server. A transaction processing module within the host computer or server may receive the request, and may search databases of customer and content information. If the transaction processing module determines that the content is available, and that the user has enough words available in their account to make the purchase, the host computer or server may transfer the writer-reader content into the user's account within the social publishing system. The purchaser would then be able to view the purchased content within the user interface.

Readers purchase amounts of words to use as currency, which are then included in a user account on the social publishing service. The readers may then spend these words to purchase content, wherein the “price” of the content is dependent upon the amount of words that make up the content. Users may also purchase an entire work in multiple transactions, buying a certain number of words that make up the entire content in each transaction. For a work that includes 20,000 total words, a user may choose to spend to 20,000 words from their account to purchase the entire work. Alternatively, a user may choose to spend 5,000 words to purchase the first 5,000 words of the work in a first transaction, with the option to purchase the remaining words in subsequent transaction.

The user interface is a robust application, and is integrated with other programs to allow for posting user activity and status updates to other social networks, as well as tracking and displaying user activity within the webpage or application program itself. The social publishing service user interface may be provided as a cross-platform application able to be executed on user devices running various operating systems, such as smartphones, tablets, laptops, or personal computers. This application may allow users to access their library of purchased or written writer-reader content, and may allow users to post and review status updates related to user activity. Digital writer-reader content may take the form of books, audiobooks, textbooks, blogs, articles, magazines, plays, screenplays, song lyrics, reader reviews/ratings/comments, essays, poems, or any other audio/video content available for sale in digital form. In order to complete transactions where the work is audio, the pricing may be based on the number of words in a transcript of the audio recording. If the audio is not in the form of spoken words, but is rather in the form of music, the pricing could be based on how many segments of a set amount of time (with the set amount of time being the “word” unit) make up the work. For example, a “word” of an audio file may be defined as one second, with 180 words making up a three minute song. For visual works, such as pictures or videos, the “word” unit may be the number of video frames, or the number of pixels in a picture. Alternative units may also be used for audio or visual works, wherein the units break the entire work down into a set number of units.

The website or application program may be stored on a server or a host computer, and may be made accessible to user devices over wired or wireless communication network connections. A central database on the server or host computer acquires and stores data related available digital writer-reader content, as well as information regarding word pricing and member profiles. The central database and server may be hosted by the social publishing service, or may be hosted by a third party. When a user accesses the website or application program, information input by the user is transmitted to the server or host computer, which responds by sending corresponding information back to the user interface, based on the users selections or entered information.

Within the social publishing service, the commerce transactions may be executed using words as the unit of currency. Money (for example U.S. dollars, Euros, or any other form of currency) may be used to buy units of words (except for the free words available), and then those units of words are used as a unit of currency to purchase writer-reader content, services offered and/or other virtual goods within the social publishing service. When a user makes a monetary purchase of words, the amount of words purchased may be placed into a user account. When the user wishes to purchase content or services within the social publishing service (which are priced based on numbers of words), the words from this user account (which may also include free words in addition to the purchased words) are used to complete the transaction. Within the social publishing service, writers sell words and readers buy words. For example, instead of purchasing individual works, users may purchase an allotment of words, and may then spend these words on writer-reader content available from the social publishing service. Additionally, writers whose content is available within the social publishing service are paid based on the number of their words purchased by readers. A multi-tiered pricing structure for words allows readers to select different payment amounts depending on how much content they read. Users may be provided with a minimum amount of words for free, or there may be a minimum price associated with a minimum amount of words. Higher levels of words may be available on a tiered pricing structure, with the price per word diminishing in each tier. For example, a user may be charged $3.00 for 10,000 words, but only $5.00 for 20,000 words. Users may select a subscription to receive to a certain number of words which are automatically placed into their account per month, or on an annual basis. Alternatively, a user may continually purchase words when the amount of words left in their account runs low. Discounts may also be offered if the user signs up for a recurring monthly or yearly subscription and users may gain additional words in their account through special promotions, gifts, or other incentive programs.

In addition to receiving words through payment purchases, users may be provided with words in their accounts by creating and submitting reviews of writer-reader content. The amount of words provided to a user for submitting reviews may also be part of the multi-tiered structure. Users purchasing words in the upper tier levels may be provided with a higher number of free words per review created than users in the lower or free tiers. The amount of review credit words may be set at different percentages within the different tiers. For example, a user in the 150,000 word tier may receive 20% of the purchased words (a maximum 30,000 words) for reviews submitted whereas users in the 10,000 word tier may only receive 5% of the purchased words (maximum 500 words) for reviews submitted.

In addition to providing a direct marketplace between writers and readers, the social publishing service may also provide an online social media community of writers and readers. Users may post messages, share status updates, or choose to follow the activity of certain others users (both writers and readers). The social publishing service may include a tracking module to track user activity within the site to provide users with a real-time display of trending topics, such as trending genres, keywords, writers, writer-reader content, length of writer-reader content, or other features. The trending topics may be presented as a list, as graphics or word art, or within an animation on a home page of the social publishing service. Real time leader boards of top readers and top writers may also be displayed to further enhance the social media and game aspects of the service. This allows readers, and writers, to compare their own reading, writing and reviewing achievements to those of other users. Writers and readers may compete against each other to obtain a place on the leaderboards, or to obtain more positively rated works or reviews than their friends, thereby introducing a gamification of the use of the social publishing service. As described below, this tracked activity may also be incorporated into a data metric subscription service with a data metrics platform, where interested parties may purchase information regarding reader and writer activity within the social publishing service. The data metrics platform, as described below, may be connected to or incorporate the tracking module. In some embodiments, the data metrics platform may be used to generate the real-time displays of trending topics for display on the user pages and to generate reader and writer rankings in the social publishing service.

Therefore, the social publishing service of the present invention provides users with a comprehensive platform and online community directly linking writers and readers. The social publishing service uses words as the units of currency, where readers buy an allotment of words that they can then spend on any writer-reader content and writers are paid based on the number of their words purchased by readers. Additionally, the social publishing service provides a user interface module allowing readers to view any purchased content, as well as make comments on the content, refer/gift/loan the content to others, and post reviews of the content. Writers are provided with a user interface module allowing them to upload previously drafted works, edit existing works, or write new works. Any works saved by a writer within the writer interface module may be uploaded to the social publishing service to be purchased by readers. When the writer member uploading the content is not an individual, but is rather an organization such as a publishing company, the works may be uploaded by the organization as the member or by individual writers who may be added as sub-members to the organization. An organization such as a publishing company may register as a writer member within the social publishing service. The social publishing service may provide the option to allow an organization writer member to register individual writers, or groups of writers, as sub-members affiliated with the same account. This may be done by using a category code to link writers to the organization account. Thereafter, works may be uploaded by the organization as the member, or by any writer affiliated with the organization member account.

When an organization is registered as a writer member with an account having sub-members, payments for any works affiliated with the account may go directly to the organization member. The organization member may then disperse these payments to the affiliated sub-members. Alternatively, the payments could go directly to the sub-members, or could be split between the organization member and specific sub-members affiliated with the organization member. The details of how payments would flow to the organization and its sub-members may be included in the member profiles.

### BRIEF DESCRIPTION OF THE DRAWINGS

FIG. 1 is an illustration of an example home page for the social publishing service.

FIG. 2 is an example of a selected list display following a user selection of a particular option.

FIG. 3 is an illustration of a log in page.

FIG. 4 is an example of additional information displayed related to a selected reader.

FIG. 5 is an example of additional information displayed related to a selected writer.

FIGS. 6-10 are an illustration of the registration process for a user to join as a registered member.

FIG. 11 is an example of a member's personalized home page.

FIGS. 12-14 are examples of a user page following log in, including the various features displayed thereon.

FIG. 15 is an example of a user account summary page, including selectable icons that may be displayed on the user page.

FIG. 16 is an example of a reading interface.

FIG. 17 is an example of a search option provided within the reading interface.

FIG. 18 is an example of a writing interface.

### DETAILED DESCRIPTION

A system and method for providing digital writer-reader content is described, wherein the content is bought and sold using words as the unit of currency. A social publishing service may act as a digital content provider, and also hosts the website or application program accessed by users. The social publishing service includes a robust eCommerce application, a digital reader, a drafting and editing platform for writers, and a destination for user reviews and suggestions related to the digital content. The social publishing service may link with other social networking sites to provide alerts regarding user activity, share updates regarding writer-reader content, distribute user reviews of writer-reader content, or allow users to share links for content with friends. Actual loaning/gifting/lending of the content may be required to occur as transactions within the social publishing service website or application program itself.

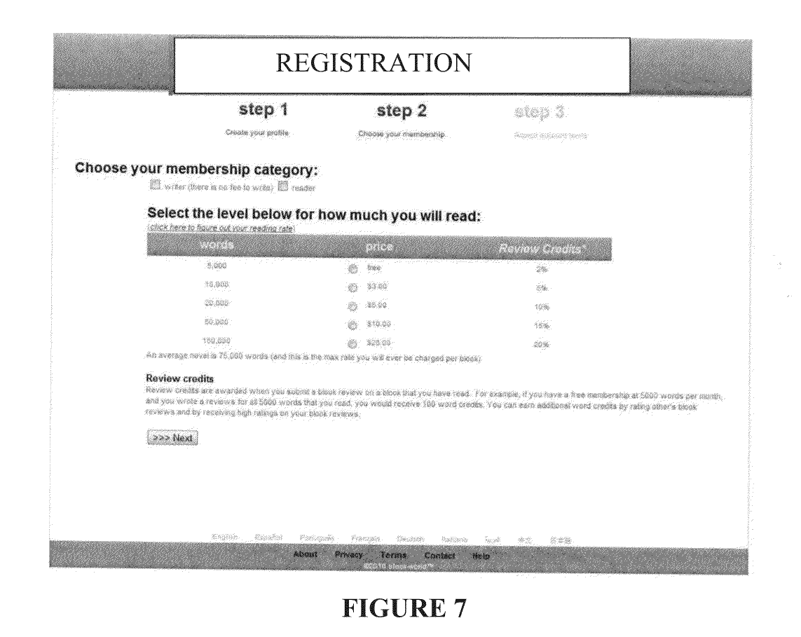

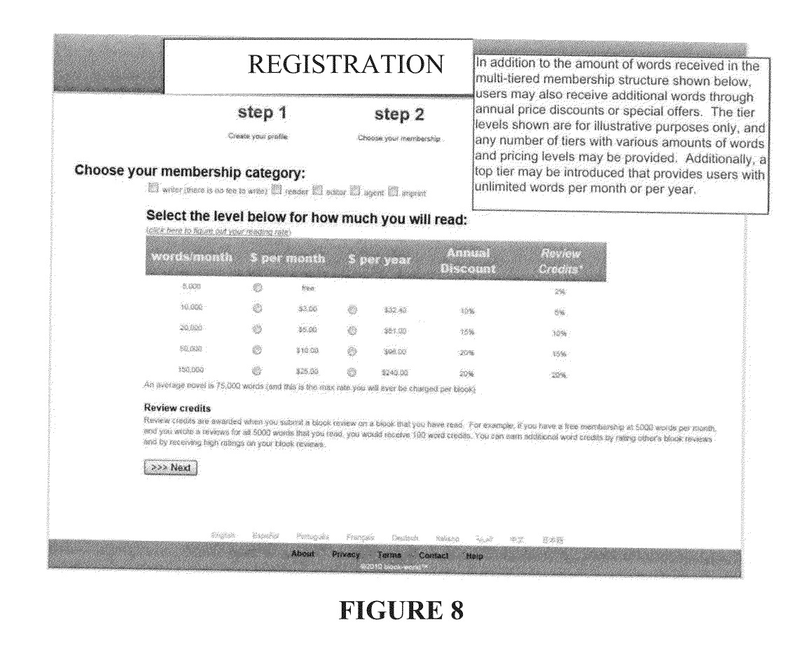

Within the social publishing service, transactions are completed by user members using words as currency—writers sell words and readers (such as user members) buy words. As mentioned above, money (for example U.S. dollars, Euros, or any other form of currency) may be used to buy units of words (except for the free words available), and then those units of words are used as a unit of currency to purchase writer-reader content, services offered and/or other virtual goods within the social publishing service. Examples of how units of words may be purchased in monetary exchanges (thereby providing a user with the words to use as currency within the system) are shown in more detail in the multi-tiered pricing structures illustrated in FIGS. 7-8.

In contrast to traditional publishing, where a writer is paid a fixed amount for a work, and where a reader pays a fixed price per book or item purchased, the social publishing service completes transactions on the number of words. According to some aspects, the present invention allows for a value to be assigned per word. Writers submitting digital content for publication on the system are paid based upon the number of words in their publication. Instead of paying for individual items, readers instead are given a quantity of words that they can spend as currency. For example, a reader may purchase 10,000 words, which they could then spend on any digital content within the social publishing service. When a user requests to purchase material within the social publishing service, a transaction module receives requests to purchase writer-reader content, exchanges words from a user's account balance for the number of words of writer-reader content requested. In addition, the transaction module initiates a monetary payment transaction to the writer member associated with the purchased writer-reader content, with the amount of the payment being based on the number of words of writer-reader content purchased. In this way, a reader with an allotment of 10,000 words may choose to purchase a 6,000 word novel, three 500 word articles, and a 2,500 word magazine. As the reader spends these words on purchases, the writers of each work are paid according to the number of words of their work purchased.

In addition, advertisers, patrons, or sponsors may make words or certain works available to others. Patrons may choose to purchase a certain amount of words or works within a genre or for a particular writer, thereby making these available to readers within the social publishing service without the readers having to make the purchase themselves. Sponsors may also make certain works or amounts of words available to the public. Unlike patrons, who could remain anonymous within the social publishing service, sponsors may obtain the benefit of having their name, logo, or advertisement associated or displayed in conjunction with the words or works made available. In this manner, the sponsor is able to publicly build up good will as a sponsor of the arts. Sponsors and patrons may operate within the social publishing service by signing up as patron or sponsor members. In the alternative, patrons and sponsors may make the works available to registered users by providing advertisements or announcements along with codes for redeeming the words or works within the social publishing service.

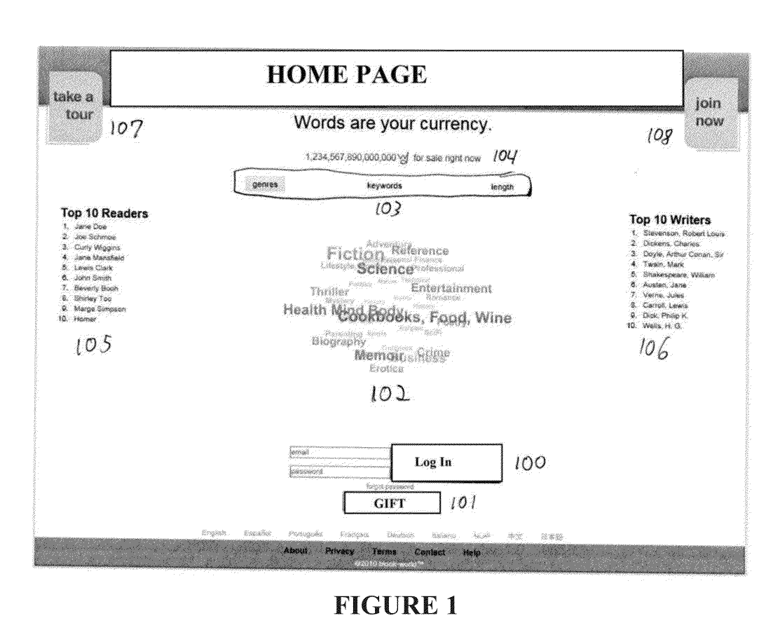

FIG. 1 illustrates a home page of the social publishing service, which may be provided as part of an online webpage, mobile application, or other interactive digital format to a user. As shown in FIG. 1, the home page provides a user with selectable options to take a tour, join as a member, gift digital writer-reader content, or sign in if they are a current member of the digital content provider system. The home page contains links for both reading and writing modules, which link the user to either reader activity pages or writer activity pages. The reader activity pages and writer activity pages may include a reading home page and writing home page, respectively. The home page shown in FIG. 1 may also be configured as a reader home page with content and options specific to using the service as a reader if the user is registered as a reader, or as a writer home page with content and options specific to writing if the user is registered as a writer.

The home page may display a user's word account balance, and also display the user's ranking compared to other users. For example, if the user is a reader, their ranking in terms of number of words in a particular genre or by a particular writer may be displayed. If the user is a writer, their rankings based on total number of words sold or number of works created in a certain genre may be displayed. The home page additionally displays information regarding the top readers and top writers within the social publishing service in various categories, including genre, total words, most reviews, most referrals, or most keyword hits.

As seen in FIG. 1, the home page may include log in 100 for existing members. If a user is an existing member, they may enter a user name and password into the log in 100, and will be directed to a personalized home page when this information is accepted at the social publishing service host server or computer. The home page may also provide users with a selectable option 101 to gift writer-reader content to others, either in the form of a selected work or as a general amount of words to be deposited in to a user account.

Selection of the gift option 101 may send a pre-paid subscription to anyone, whether they have an account or not. If the person receiving the gift has an account, they can add the gift directly into their existing account. In order to complete the gift option, a user may be required to specify the word amount or range they wish to gift. The pricing of the amount of gifted words may be determined by a multi-tiered pricing structure, as described in more detail below. The user may also be asked to provide an email address, mobile phone number, social media screen name, or other identifying information about the recipient which would allow them to receive the gift. Gifts may also be provided in print form, with a code to access the gift award. Gifts may be tracked by the social publishing service, such that members who provide gifts to others receive word credits in their accounts. There may be no requirement to join in order to buy and send a gift, although membership may be encouraged by providing word credit incentives for giving the gift.

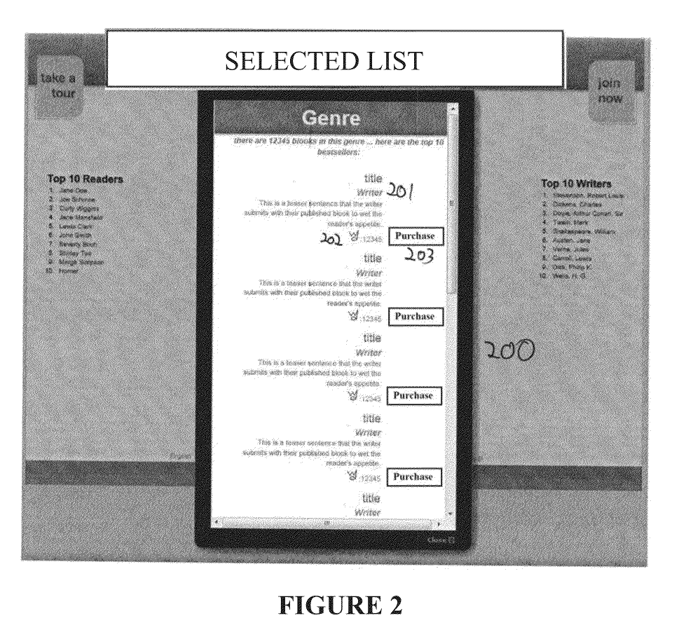

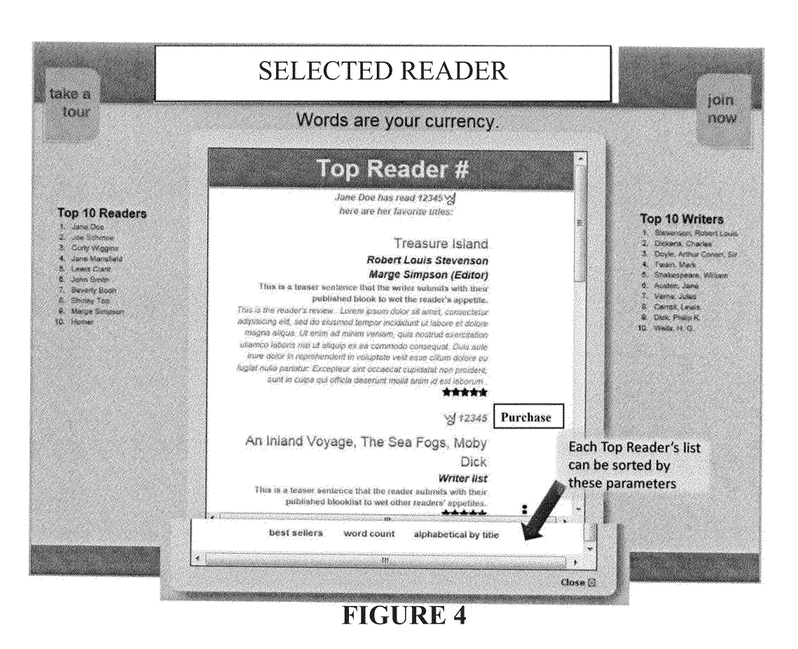

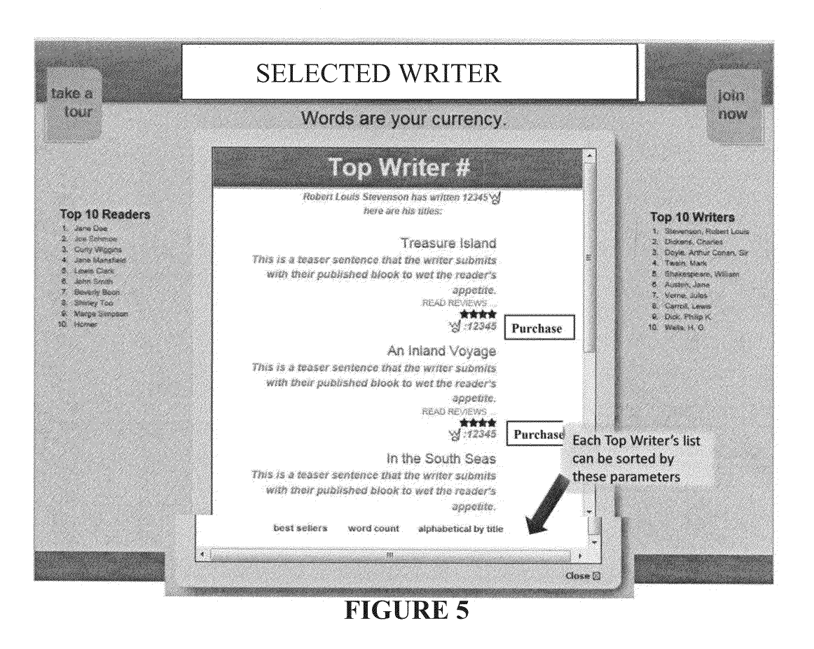

The home page may further display a Word Cloud 102, listing trending topics within different selectable categories 103, such as trending genres, writers, keywords, or word lengths. When the user selects a different category 103, the words of trending topics within the Word Cloud display 102 will change. The Word Cloud 102 may be an animation of words that continuously change and update, or it may be provided as a static or dynamic list of the top trending topics within a selected category. These lists may be interactive, wherein each word displayed acts a link that the user can click on or otherwise select. This is shown in more detail at FIG. 2. The home page in FIG. 1 may further include a real-time display of the total number of words 104 currently available for purchase. Displays of leaderboard lists of Top Readers 105 and Top Writers 106 may also be included. These leaderboards 105, 106 may be updated in real-time or at certain set intervals. The Top Readers 105 may be determined using a formula based on the number of words in a reader's library, the number of reviews written along with a review-relevancy score for each, the number of member referrals made by the user, the amount of words or writer-reader content the user has gifted or referred, the number of new members who have signed up based on referrals, invitations, or gifts from the user. The Top Writers 106 may be determined using a formula based on a number of words sold by a writer, reviewers ratings (and review quality factor) of the writer's works, gifted and referred rate, fan base, and conversion rate of users to registered members. The displays of the Top Writers and Readers 105, 106 may be presented as selectable links, such that a user may click on the name of a reader or writer from one of the lists to be directed to a new window providing additional information on that reader or writer. Examples of the additional information related to each reader or writer selected from these displays 105, 106 are shown in FIGS. 4 and 5.

The home page may further provide users with a selectable option 107 to take a tour and learn about the features of the social publishing service. Additionally, a selectable option to join 108 is provided. User may select this option to begin the process of becoming a member of the social publishing service. In order to join, users may be asked to set up a user account profile. This may include providing a real name, creating a user name, providing an email address and residential address, creating a password, and providing other identifying information such as birthday, age, gender, location, genre preferences, or preferences of writers. Information related to a user's age may be used for content restrictions. Writers may also have the option of creating a pen name in addition to a user name. The user may then be required to choose the features of their membership. This may include registering as a reader, a writer, or both. The user may also be required to choose their membership level, including the amount of words they would like to receive as a single transaction or on a monthly, yearly, or other basis. The various subscription levels may be available in a multi-tiered structure, with the cost per word decreasing as the total number of words purchased increases.

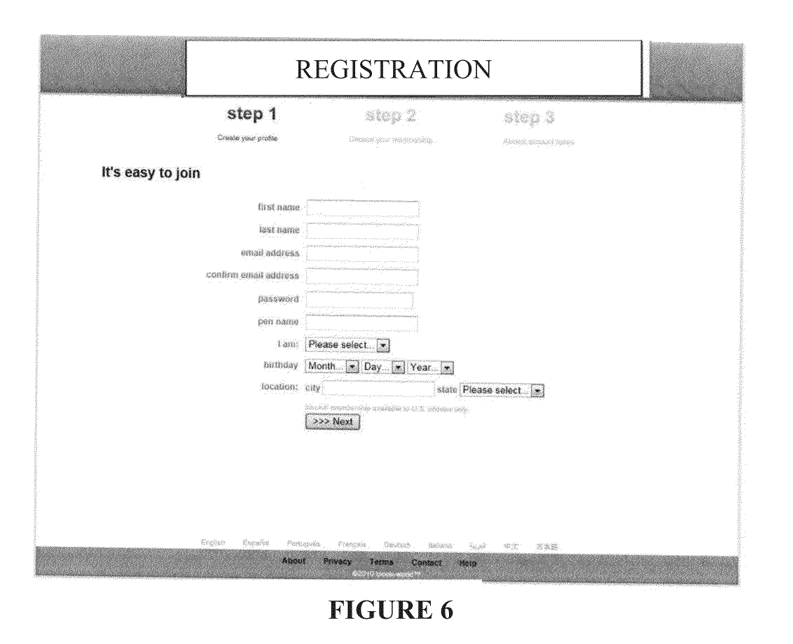

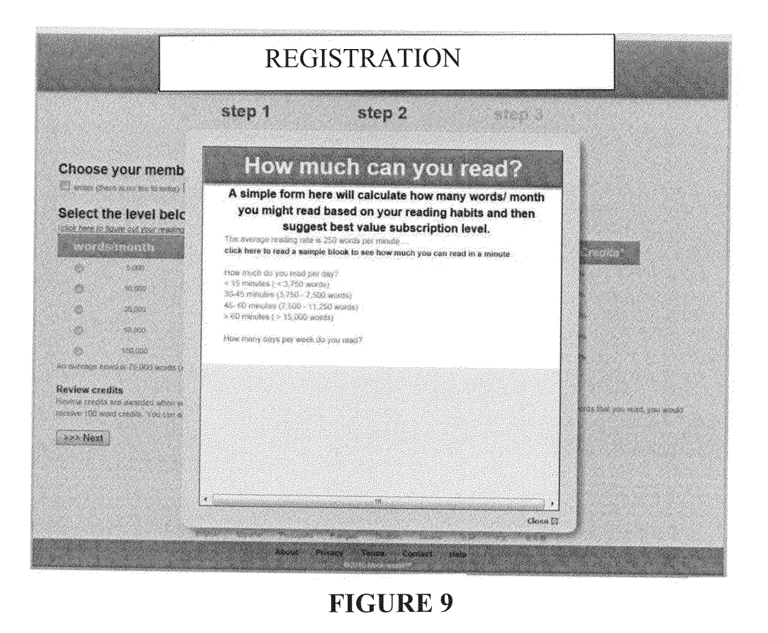

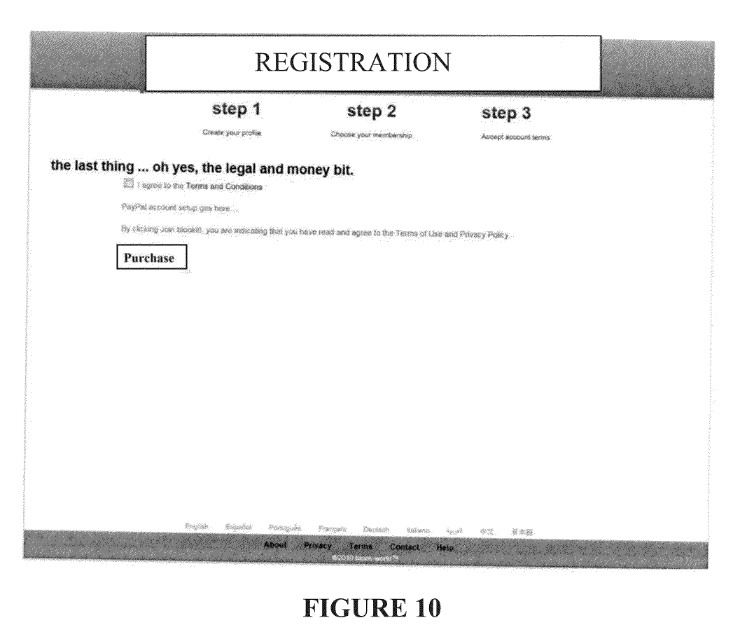

Examples of the process for joining as a registered member, including examples of the multi-tiered pricing structure, are illustrated in FIGS. 6-10. In order to help a reader determine the level of membership that may best suit them, a module may be presented which helps the user to determine how many words they may read in a given time period, such as illustrated in FIG. 9.

The reader member may be an individual, organization, company, university, library, or social group such as a book club. The writer member may be an individual writer or affiliated with a publishing company, a university, a business or company, or any other organization. A writer may be the creator of any type of writer-reader content available within the social publishing service, including written works, drawings, visual works, audio works, compilations of other works, or edited works. When the writer member is a publishing company, the publishing company may gather content from individual writers (who may or may not also be members) and facilitate uploading this content as a group collection to the social publishing service. The publishing company may be a writer member, and may be able set its profile so that it is recognized as an organization or group member within the system. Individual writers or groups of writers may be affiliated with the organization or group member within the system as sub-members. After a publishing company, for example, creates an account (which may be a separate membership sign up form), then writers associated with that publishing company could be assigned to that group member account via a category code for linking their user accounts.

As mentioned above, when an organization is registered as a writer member with an account having sub-members, payments for any works affiliated with the account may go directly to the organization member. The organization member may then disperse these payments to the affiliated sub-members. Alternatively, the payments could go directly to the sub-members, or could be split between the organization member and specific sub-members affiliated with the organization member. The details of how payments would flow to the organization and its sub-members may be included in the member profiles.

The publishing company may be viewed by the digital content provider as the writer client, and any purchase transactions involving the content/associated with the publishing company would be processed such that the publishing company is paid according to the number of words of the associated content purchased by reader members. Similarly, when the writer member is a university or other organization, payments for digital content purchased by reader members is paid directly to the organization's account with the digital content provider. The digital content provider may also allow a writer member that is an organization, as opposed to an individual writer, to set up a distribution of payments within the writer member's profile.

In addition to registering as readers or writers, options may be provided for users to register as editors, agents, translators, audio book readers, patrons, sponsors, advertisers, publishers or other types of service providers who may be compensated for their services in the form of word currency or monetary currency. The social publishing service may further allow users to register as data metric subscription service members. The social publishing service may keep track of the biographic information of registered readers and writers, as provided during the membership log in process described above. The social publishing service may also create reader/writer data metrics based on tracked reader and writer activity within the social publishing service, which may include aggregate user data, specific user data, and data on words in the system.

This data metric subscription service may be operated as a platform within the social publishing service, and would allow interested individuals or entities the ability to purchase data on the activities of readers or writers within the system, such as data metrics indicating reading and writing trends within different demographic groups, and trends and popularity within and between genres, or recent activity of particular writers. The data metric subscription platform may include a purchasing portal, wherein members may purchase various levels of data metrics. The platform purchasing portal may allow members to make one time purchases of data in relation to a particular request, or the members may sign up for daily, weekly, monthly, or yearly data access subscriptions. There may be different pricing for the subscriptions or search requests based on the amount of data requested. For example, access to data tracking the activity of one particular writer may cost a data metric subscription service member less than access to data on reader trends within an entire demographic group.

Data metric subscription service members may include book publishers, magazine publishers, filmmakers/studios, and advertisers. By subscribing to the service, book publishers could track the activity of their writers within the system, or could obtain data on up-and-coming writers gaining in popularity that they may wish to contact. Film studios may use the data to determine which genres or works are popular among different demographic groups, giving them insights into works that may be popular if made into movies.

The data metric subscription service platform may include a central processing unit used to execute software code in order to control the operation of the platform. This may be the same central processing unit operating and hosting the social publishing service pages, or it may be a separate processing unit in communication with the server or computer hosting the social publishing service. The platform may include read only memory and random access memory, at least one communication network interface to transmit and receive data to and from other computer devices, and database storage such as a hard disk drive, flash drive, cloud storage, CD-ROM, DVD-ROM and the like for storing program code, databases and application data. As users, such as readers and writers, interact with content in the social publishing service, the data metrics platform collects, stores, and analyzes data related to the activity of each specific user and the aggregate activity of all users. This data may include not only content posted by writers or read by readers, but also data on searches performed within the system, genres visited, or messages posted within the online community. All of the activity related data that is tracked, stored, and analyzed may be stored in the database storage. This database storage is then indexed and searched by the platform, and data results are output to data metric subscription service members on their user pages.

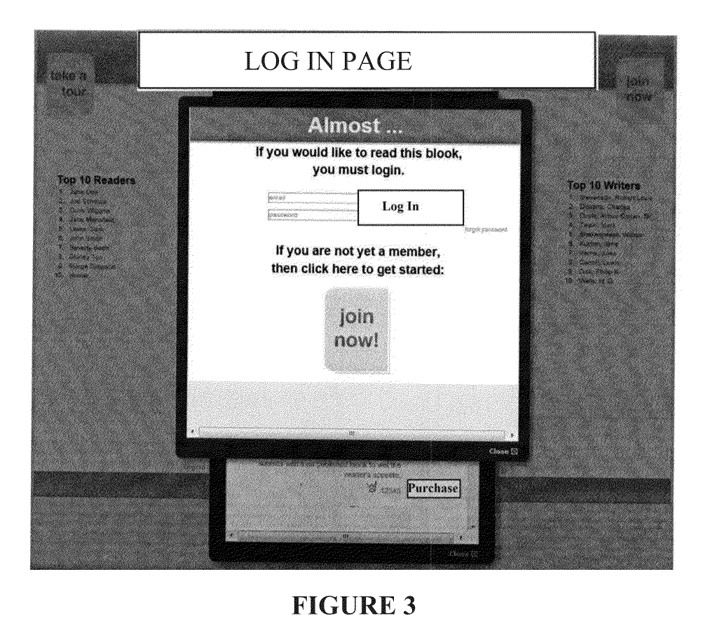

FIG. 2 provides an example of a list which may be displayed if the user selects an option on the home page to receive information about the top selling works within a certain genre. Upon making such a selection, a new window may be displayed within the home page or as a new webpage providing information related to the selected word, such as total number of occurrences of that word in the available writer-reader content, lists of titles and writers that either used that word most recently or that have the greatest occurrences of that word within certain works. This information may be provided in the form of an interactive list 200, which may display information about the top 10 works or writers related to the selected word. Included in the list may be information 201 about the works, such as the title, writer, and a preview of the work (such as a sentence, page, illustration, or paragraph). The interactive list may also display the total words 202 included in the work, allowing the user to determine if they have enough words in their user account to purchase the work. A selectable option 203 may be provided initiates a process to complete a transaction to purchase the work, or to view the work if the user is already a registered member. The selectable option may automatically complete the transaction and move the selected work to the user's purchased content library if the user has enough words in their account. Alternatively, the selectable option 203 may direct the user to a separate window or webpage to complete the purchasing transaction. The user may set purchasing preferences within a user profile when they join the social publishing service. As shown in FIG. 3, in order to read the selected work the user will be provided with a screen to enter their log in information. If the user is not already a registered user, this screen may also provide them with a selectable option to begin the process to become a member.

According to some embodiments, the home page may allow all users to view and search certain information on materials available for purchase or otherwise available for review. For examples, users may be allowed to search and view titles of available works, lists of authors, lists of works by a specific authors, or lists of genres or most popular works within a specific genre. However, a user may be restricted from reading materials until they are logged in. In some instances, a user may be allowed to read a certain preview amount of a work without being required to log in, with a log in then required to view more of the work.

The content available for viewing may depend on the type of member logging in. For example, a logged in publisher or sponsor may see different content than a logged in writer or reader. A sponsor may only see who has viewed sponsored content, while a subscription service member may see information on the data metrics of users within the system depending on the information they have purchased, such as recent activity of a particular writer, what writers are popular now, genre trends, and registered users within various demographic groups.

After a user has registered with the home page, they may log in on the home page. Upon logging in for the first time, a new user may be directed to an introduction of the features of the social publishing service available on the webpage or application program. These may include help tutorials instructing the user how to search for writer-reader content, refer writer-reader content to friends, review writer-reader content and rate the reviews posted by other users, loan content, gift content, and create content lists (such lists of content to publish, refer, loan, or gift, or a list of content in a user's account library). The introduction may also include a tutorial on the various features available to writers as part of a Writer's Toolkit. The Writer's Toolkit may include writing tools, such as a dictionary, thesaurus, guides on formatting, style guides, or inspirational pieces. The Writer's Toolkit may further include business information relevant to the writer, such as information on copyright and copyright submission, editors, and agents. For example, a list of agents/editors who are available for hire and/or recommended based on user account profile matches could be made available, along with information on how to establish a relationship with the agents/editors listed. Information on marketing may also be provided to the writer. This may include information on effective advertising, creating promotions, generating and interacting with a fan base. A tracker may also be provider within the Writer's Toolkit, which allows the writer to track the number of words they are selling, as well as identify the different readers who have purchased their words. This tracker may be provided as a tracking module in the programs executed by the social publishing service server or host computer. The server or host computer may execute a program to track user activity and transactions by reviewing data sent from and to user members. The tracker may also search information in the database to follow user activity. Through the tracker, the writer may be able distribute alerts or announcements to those that have purchased their words.

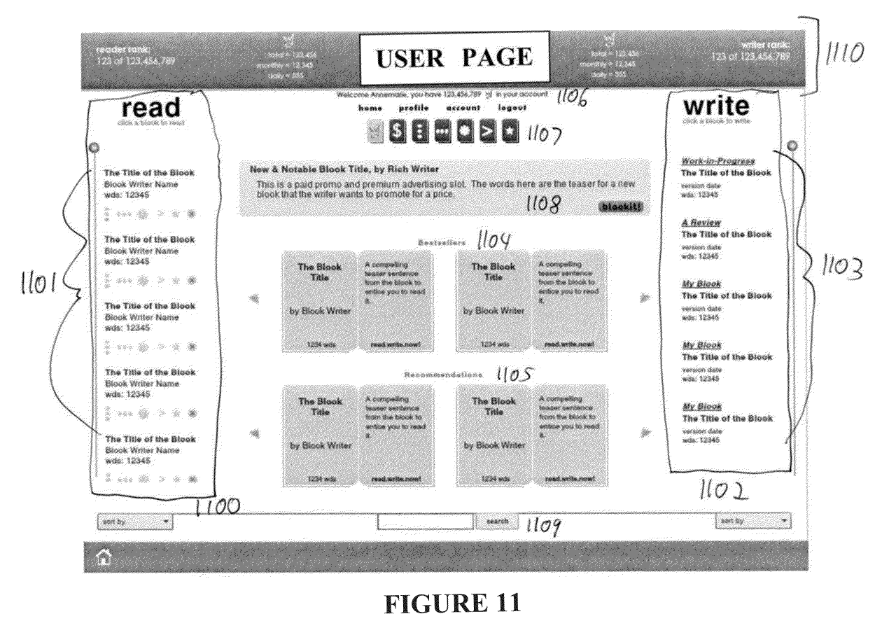

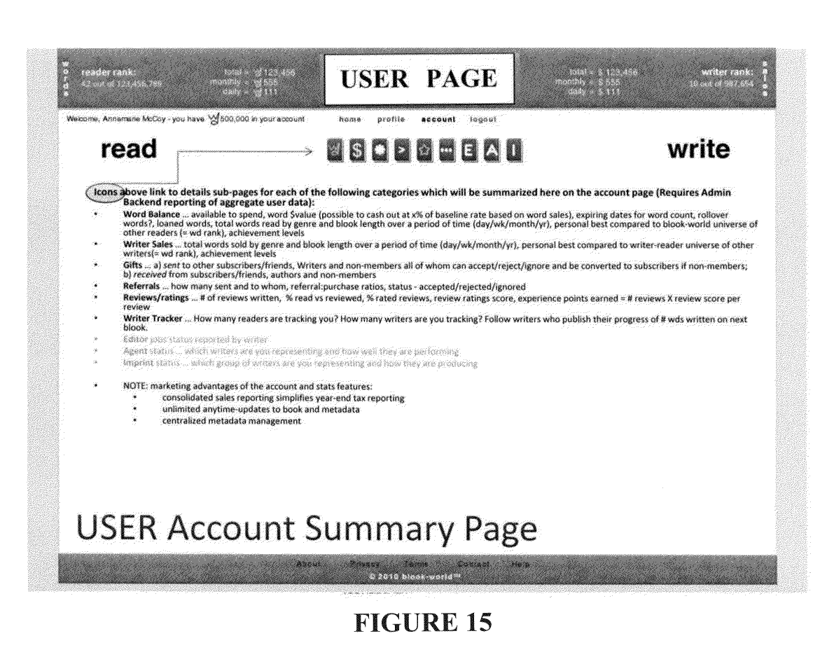

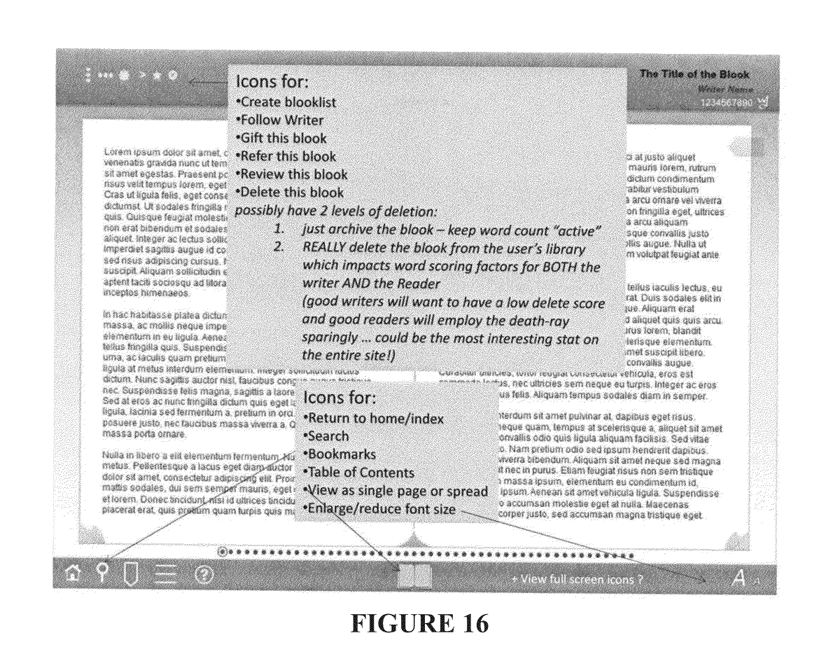

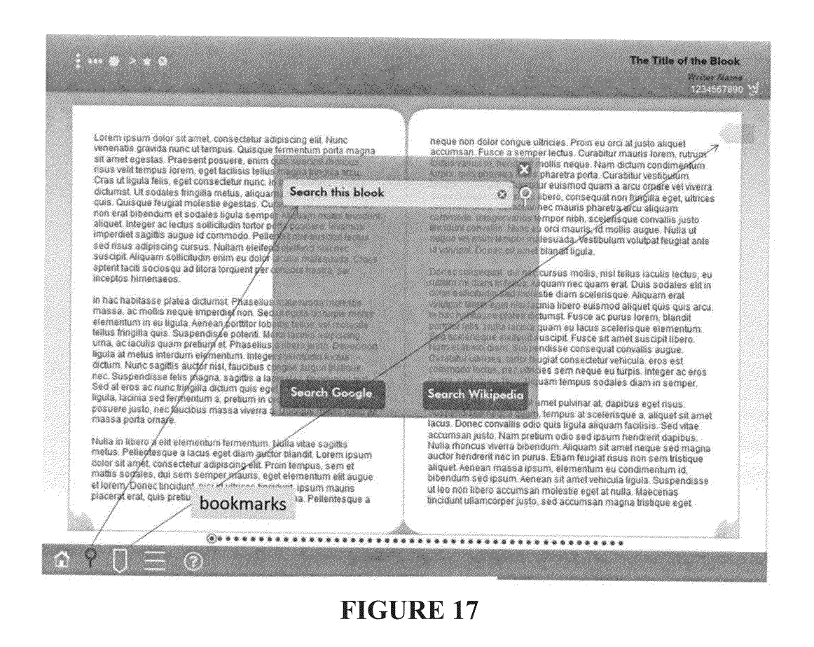

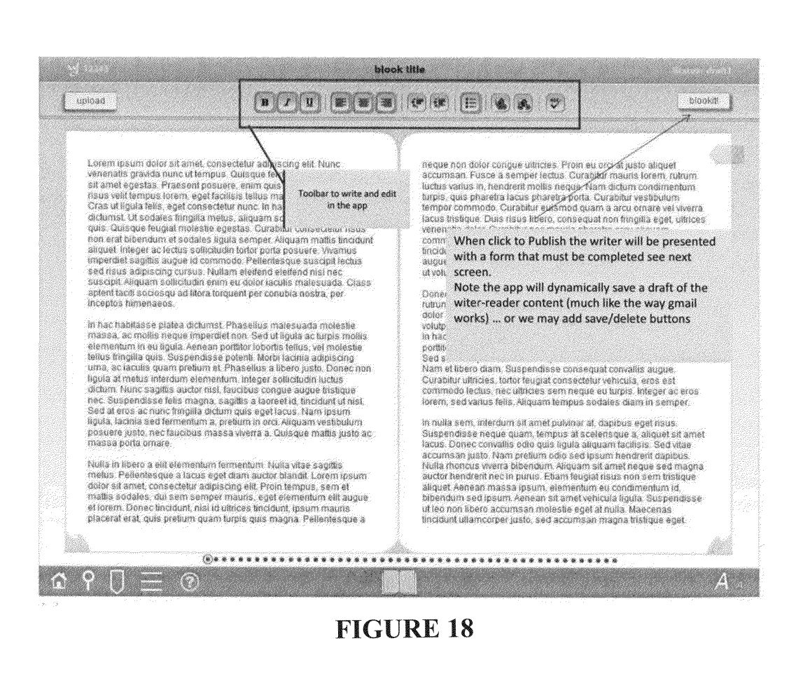

Once a member logs in they are directed to a personalized home page, as shown in FIG. 11. The member's home page may include a section related to reading 1100, and a section related to writing 1102. Within the reading section 1100, the member may be presented with a selectable reading list 1101 of writer-reader content in the member's library. The member may click on, or otherwise select, any item within the list 1101 that they would like to read, and that item may be displayed in a reading interface, such as shown in FIGS. 16-17. Similarly, a member may select any item within a selectable writing list 1103 in the writing section 1102. Selection of an item in the writing list 1103 may cause the member to be directed to a writing interface, such as shown in FIG. 18. A member status display 1110 may be included on the personalized home page. The status display 1110 may include such information as the member's reader and/or writer ranking, as well as the total number of words read or written in a given time period. An account status 1106 may be included, which indicates the number of words that a member has available to spend in their account. The member home page may also include selectable icons 1107, which link to detailed subpages for various categories of activity a user may undertake within the social publishing service website or application program. Examples of these selectable icons which may be included on a member home page are shown and described in FIG. 15.

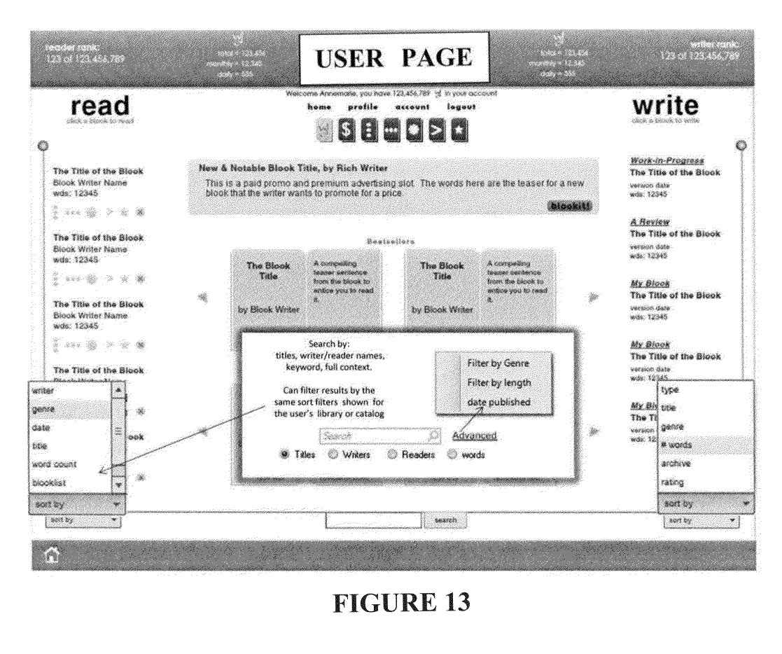

In addition to member-specific information, the member's home page may display advertising or promotional materials. These may take the form of interactive, selectable advertisements directly included on the webpage, such as advertisement 1108. Advertisements may be paid for by a writer, reader, publisher, or any other entity. Additionally, they may take the form of a display of bestsellers or new content displays 1104. Recommendations may also be provided on the member home page, as shown at 1105. A search tool 1109 may be provided, allowing a member to enter any keyword, name, or title. The search may be performed within the member's personal library of purchased content or written content, or may be performed within the entire database of available material maintained at the social publishing service's server or database. FIG. 13 provides an example of the search tool.

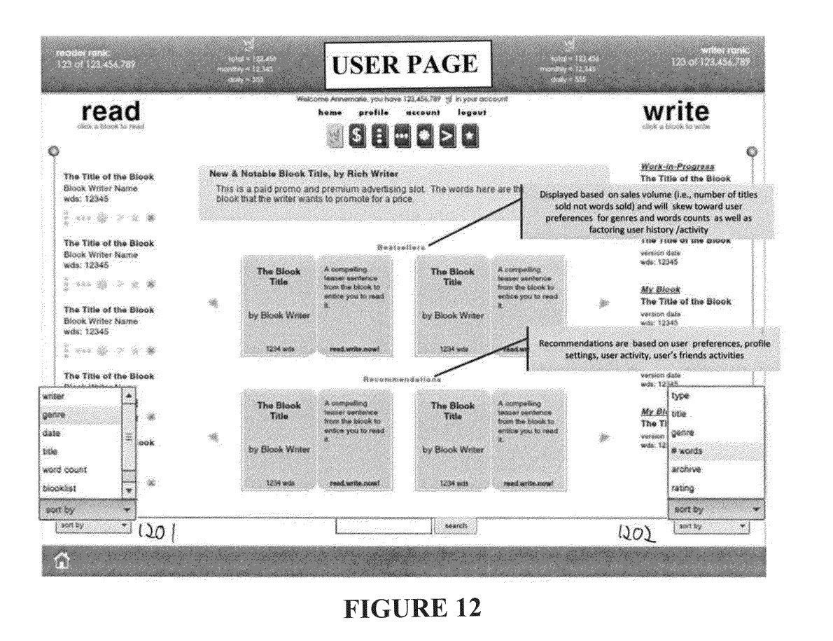

As shown in FIG. 12, the bestsellers displayed on the member home page may be based on sales volume by title or writer. The bestsellers display may also be generated such that it skews towards member preferences for genres, writers, or word counts while also taking into account the member's activity and history. Additionally, efforts will be made to detect writer members who might try to game the system by purchasing multiple copies of their own work in order to push their sales ranking up in the Bestseller ranks. Since a writer cannot write a review of their own work, their review-relevancy score will be very low in contrast to their Bestseller status. The recommendations may be based on member preferences, profile information, recent purchases, writers followed, member activity, and the activity of other members with similar profiles, preferences, or purchases. FIG. 12 also illustrates selectable sort features 1201, 1202 that may be provided for the reading section and writing section of the member home page. Within the sort features, a member is able to sort the lists in the reader or writer section according to various selectable options.

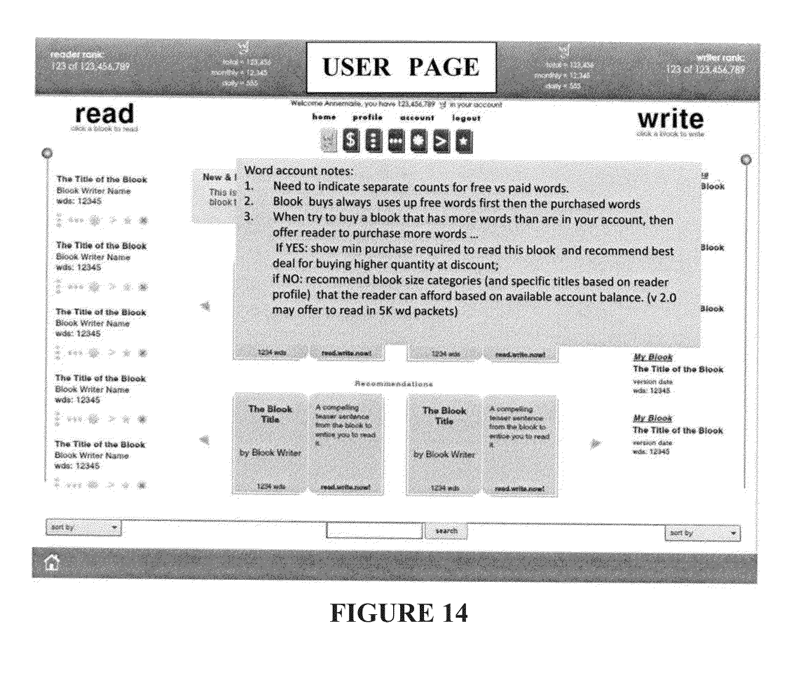

As shown in FIGS. 11-14, the total number of words may be included for each item of writer-reader content displayed. This helps members in determining whether to purchase certain items of content, based on the amount of words left in their account or the price required to obtain enough words to complete the transaction. As shown in FIG. 14, the social publishing service may be able to differentiate between counts for free words, and counts for paid words. When a member purchases content, the system may be programmed such that free words are always used first, and then purchased words are used if the balance of free words is insufficient for a particular transaction. If a member attempts to make a purchase that exceeds the number of words left in the member's account, the member may be provided with an option to purchase the additional amount of words required. If the member chooses not to purchase the additional words necessary, the system may provide the member with alternative options within the member's current word account limit.

As mentioned above, the online website or application program may also provide the user with a reading interface on which to read and interact with writer-reader content in the user's library. The reading interface may include a reading pane that displays text, images, or other visual content. The reading interface may also play music or other sounds through audio speakers on the user device, and may display animations or movies. As shown in FIG. 16, the reading interface includes selectable icons allowing the user to navigate through and interact with the content, such as inserting a bookmark, increasing/decreasing text size, sharing or posting comments regarding the content over social media, or inserting comments or notes related to the displayed text or other material. As shown in FIG. 17, a search option may be provided allowing the user to search within the writer-reader content being viewed, within the entire social publishing service, or within a local network or the internet in general. The user may also be provided with options to edit the content, including adding or deleting text and tracking changes and revisions. A user may also post comments, live chat with others, or receive inbox messages while reviewing content in the reading interface.

Within the social publishing service website or application program, a user acting as a reader can engage in a plurality of reading activities. These activities may include finding new writer content to read, referring content to friends, reviewing content and rating reviews posted by others, loan content or gift content. A reader may also create and store lists of writer-reader content. For example, a user may create lists based on writer, word count, genre, date, keyword or theme such as expressing sentiments like sympathy, joy or humor. A reader may also create lists of content that they wish to share, publish, refer, loan, or gift. These lists may be stored locally on the user device, or may be stored on the server or database hosted by the social publishing service. A reader may add or delete specific items from the lists, or may delete entire lists. Readers are also provided with options to track and follow particular writers or other readers. For example, readers may follow a writer's progress on new releases, serialized portions of their work-in-progress, cliff-hanger chapters or receive special fan offerings. Readers may also receive status updates regarding the content recently viewed, reviewed, or shared by other readers. Readers may contact writers (if allowed by a writer as indicated in the writer's user profile) in the form of chat or inbox messages.

Users acting as writers within the social publishing service website or application program may engage in a plurality of writing activities. From the member home page, writers may access a writing interface. This writing interface allows a writer to draft and edit content directly in the social publishing service website or application program. Once a work is completed, the writer can select to have the work published, or uploaded into the database of available materials on the social publishing service. Once this is completed, the writer's work will be available for purchase by readers, and the writer can begin receiving payments when the work is purchased. The social publishing service may set membership requirements, for example a minimum fan base, which must be met before a writer can receive payments. An example of a writing interface is shown in FIG. 18. A Writer's Toolkit may be provided within the writing interface, on the member's home page, or as a separate window. Writers may upload text files, image files, or any other materials that were created offline or outside of the social publishing service. The social publishing service may convert these materials into a format that can be viewed and edited within the social publishing service website or application program. As discussed above, selectable icons linking a writer to materials such as a dictionary, thesaurus, or style guide may be provided.

As mentioned previously, members of the social publishing service have the option to review writer-reader content. According to some aspects, writers may be prevented from reviewing their own works. Readers who post reviews of writer-reader content may receive word credits. These word credits may be placed into a reader's account when a reader creates a new review, or rates a review created by another. The value of a reader's review is awarded/augmented by its relevancy rating received from peers. Readers are encouraged to rate others' reviews in order to increase the value of their own review credits. For example, a reader may write a review of certain content, but until other members rate the “quality” of that review, the full value of review credits are not awarded. When the credits are awarded, they may be weighted by the rated quality of review and any review-relevancy-rating scores. The “quality” of a review may not necessarily be determined by whether others like or dislike what they have read, rather there may be certain questions that must be answered by other reviewers/readers such as whether copyrights were violated or if the review was relevant to the writer-reader content and whether certain keywords were found in the reviewer's comments.

Writers and readers within the social publishing service community may refer and loan books, or become patrons to aspiring writers. When a member refers writer-reader content, the member may receive word credits in their account. A member may receive additional credits if the referred writer-reader content is purchased by the person to whom the referral was sent. The system may track the number of referrals a reader sends, to whom they were sent, and whether the referrals resulted in purchases. According to some aspects of the present invention, members may also loan writer-reader content if they are a paid member. A maximum number of loans per user may be set, and the maximum may be different depending on whether the loans are provided to other members or to non-members. Non-members receiving loan invitations must either accept or reject the loan invitation. If the non-member accepts a loan invitation, they may be required to become a member of the social publishing service before being able to view the loaned material. As with referring content, a member who chooses to loan content to others may receive word credits based the number of new members who sign up after receiving the loan. A sliding scale of value based on invitations, referrals, gifts sent, and the number of new members who sign up in response is used to determine the number of word credits given. When writers receive credits, for example from invitations accepted, new members signed up, gifts sent, or referrals, they may use these credits to purchase writer-reader content within the system. Alternatively, writers may be allowed to convert the word credits received into monetary value. This may be done using the same payment scale for words that they have sold. Writers may also use credits received to increase the percentage of each sale that they receive. For example, if a writer earns a certain number of word credits, they may be eligible for higher percentages of each sale of their work.

As mentioned above, commerce transactions within the social publishing service occur when a reader spends words from their account to purchase a writer's content. Word amounts are used as the currency for the transactions, with readers spending words and writers being paid based on the number of their words purchased. Writers may receive a percentage of the revenue generated from each sale of their work, with the social publishing service receiving a percentage. Software programming run by the social publishing service may record each time a writer's work is “read” (purchased), and may determine how much to pay the writer for the work. The value of a word may be fixed at a certain rate within the service. The value per word may be calculated on the current market price of an average length printed/digital book divided by the number of words it contains. The price per word may be set for all works within the social publishing service, or different values per word may be set based on the type of work, writer, publisher, word count in the work, date the work was published, among other factors. For example, works listed on bestseller lists or by more popular writers may sell for a higher price per word than works by amateur or unknown writers. As another example, the price per word for novels may be higher than the price per word of newspaper or magazine articles. The price per word may also vary dynamically, based on supply and demand. The revenue to the writer is based on the number of words sold, multiplied by the value per word and then the percentage of each sale given to the particular writer. A maximum amount paid per work may also be included, with a writer only receiving payment up to a certain amount of words.

Writers may also increase their revenue by inviting new members or referring works to readers, which are then purchased. Writer referrals may impact the writer's percentage of revenue obtained from each sale, and may further increase a writer's leaderboard score which is taken into account when determining the percentage of each sale attributed to the writer. Fans may also be an integral factor to the writer's commission rate. In order to be eligible to receive any payments, the social publishing service may require that a writer has a certain number of fans. Until the writer reaches this minimum number of fans, they may not be entitled to any percentage of the revenue from sales of their work. As a writer increases the number of fans they have within the social publishing service, the percentage they receive for sales of words may increase.

The terms “blook,” “blookit,” or “blookit!” may appear in the attached Figures generic terms for the content within the social publishing service. When used herein, the term “blook” refers to any writer-reader content that may be available through the social publishing service.

1. A system for the creation and distribution of writer-reader content, the system comprising:
a registration module for receiving registration information from system users, wherein communications are received at a host communication interface;
a user account module for receiving and storing user preferences and word account balances, wherein the word account balances are based on purchased quantities of words for use in transactions on the system;
a content database storing writer-reader content;
a transaction module for receiving requests to purchase writer-reader content, wherein the writer-reader content is valued by the number of words, and wherein a purchase is completed by the transaction module by exchanging words from a user's account balance for the number of words of writer-reader content requested.

2. The system of claim 1, further comprising a tracking module configured to track and store user activity related to writer-reader content.

3. The system of claim 2, wherein the tracking module is connected to a data metrics platform, and wherein the data metrics platform is configured to aggregate, display and transmit data related to user activity within the system.

4. The system of claim 2, wherein the tracking module is configured to aggregate tracked user activity related to writer-reader content, and to generate rankings of users within the system based on interaction with the writer-reader content.

5. A method for distribution of writer-reader content, the method comprising:
receiving writer-reader content;
determining the number of words in the writer-reader content;
receiving a request for the writer-reader content from a user;
reviewing an account or profile associated with the user, wherein the account of profile includes a balance of word units available to the user;
transmitting the requested writer-reader content to the user, wherein words from the user's balance available to the user are exchanged for a corresponding amount of words of the writer-reader content.

6. The method of claim 5, further comprising tracking and storing user activity data related to writer-reader content.

7. The method of claim 6, further comprising providing user activity data to a data metrics platform, and wherein the data metrics platform aggregates, displays and transmits the user activity data.

8. The method of claim 6, further comprising aggregating tracked user activity related to writer-reader content, and to generating rankings of users within the system based on interaction with the writer-reader content.

9. A method distribution of writer-reader content, the method comprising:
receiving writer-reader content from a writer member;
determining the number of words in the writer-reader content;
receiving a request for the writer-reader content from a user;
transmitting a payment to the writer member, wherein the payment is based on the number of words of the writer member's writer-reader content purchased.

10. The method of claim 9, further comprising tracking and storing user activity data related to the requested writer-reader content.

11. The method of claim 10, further comprising providing user activity data to a data metrics platform, and wherein the data metrics platform aggregates, displays and transmits the user activity data.

12. The method of claim 10, further comprising aggregating tracked user activity related to writer-reader content, and to generating rankings of users within the system based on interaction with the writer-reader content.

13. A system for the creation and distribution of writer-reader content, the system comprising:
a registration module for receiving registration information from system users, wherein communications are received at a host communication interface;
a user account module for receiving and storing user preferences and account balances, wherein the account balances are based on purchased quantities of words for use in transactions on the system;
a content database storing writer-reader content;
a transaction module for receiving requests to purchase writer-reader content, wherein the writer-reader content is valued by the number of words, and wherein a monetary payment is made to a writer member associated with the purchased writer-reader content by the transaction module, the amount of the payment being based on the number of words of writer-reader content purchased.

14. The system of claim 13, further comprising a tracking module configured to track and store user activity related to writer-reader content.

15. The system of claim 14, wherein the tracking module is connected to a data metrics platform, and wherein the data metrics platform is configured to aggregate, display and transmit data related to user activity within the system.

16. The system of claim 14, wherein the tracking module is configured to aggregate tracked user activity related to writer-reader content, and to generate rankings of users within the system based on interaction with the writer-reader content.
